(19) United States
(12) Patent Application Publication
(10) Pub. No.: US 2015/0070927 A1
(43) Pub. Date: Mar. 12, 2015

(54) MOISTURE REMOVAL DEVICE, LIGHTING DEVICE FOR MOUNTING ON VEHICLE, AND LIGHT SOURCE LIGHTING DEVICE

(71) Applicants: Masato Kurahashi, Tokyo (JP); Naoki Sawai, Tokyo (JP); Takashi Ohsawa, Tokyo (JP)

(72) Inventors: Masato Kurahashi, Tokyo (JP); Naoki Sawai, Tokyo (JP); Takashi Ohsawa, Tokyo (JP)

(73) Assignee: Mitsubishi Electric Corporation, Tokyo (JP)

(21) Appl. No.: 14/381,956

(22) PCT Filed: May 24, 2012
(86) PCT No.: PCT/JP2012/003395

§ 371 Date: Aug. 28, 2014

(51) Int. Cl. F21V 23/02; B01D 53/26; B01D 53/32; B01D 53/30; F21S 8/10; G01N 27/407

(52) U.S. Cl. CPC F21V 23/02; F21S 48/31; G01N 27/407; B01D 53/32; B01D 53/30; B01D 53/26
USPC 362/546; 204/230.2; 204/426

(57) ABSTRACT

A moisture removal device 10 actively discharges moisture in a complex-shape headlamp 1 using an electrolyte member 14. In order for the electrolyte member 14 not to be heated up when the moisture removal device 10 is used in an atmosphere in which a combustible gas exists, electrode members 19, 20 made of a metal having a sufficient heat-transfer effect are used. Further, by use of electrode portions 15, 15a of the electrode member 19, an opening portion 13 of a cylindrical convex portion 12 that protrudes into the headlamp 1 is closed, to thereby protect the electrolyte member 14.

### TECHNICAL FIELD

The present invention relates to a moisture removal device using a plate-like or film-like electrolyte member, a light assembly for on-vehicle use (lighting device for mounting on vehicle) that removes moisture inside the assembly using the moisture removal device, and a light-source lighting device incorporating the moisture removal device.

### BACKGROUND ART

With respect to light assemblies for on-vehicle use, such as headlamps and the like, in some cases, moisture that is being potentially included in a resin constituting respective members of the assembly, or moisture that has been intruded from the outside because of expansion and contraction of air in the light assembly due to repetitive light-on and light-off operations by a light source in the light assembly, is condensed on a low temperature portion inside the light assembly.

In particular, a lens that constitutes an externally-exposed front face of the light assembly and projects light from the light source ahead of the vehicle, is a portion that often becomes a temperature lower than the other portions, so that a dew condensation is likely to occur at the inner side of the lens. To make matters worse, the lens is transparent and thus water droplets due to condensed water produced at the inner side is likely to be visually recognized as a haze, thereby degrading merchantability of the light assembly.

It should be noted that, nowadays, in the light assemblies each having a complex shape that constitutes a part of the vehicle body line, a higher-to-lower difference in temperature distribution of the air in the light assembly is large, so that a low temperature portion is likely to be developed and thus a dew condensation is likely to be evident at the low temperature portion.

Meanwhile, as compared to the conventional light sources such as light bulbs in which a tungsten filament is red heated, new light sources such as discharge lamps and LEDs (Light Emitting Diodes) need lower power for lighting, and thus the temperature rise inside each of their light assemblies is moderate as a whole. Accordingly, expansion and contraction of air in the light assembly are reduced, so that the moisture intruded in the light assembly becomes hardly dischargeable to the outside. As a result, the moisture is likely to be accumulated in the light assembly, thereby making a dew condensation likely to be evident.

Note that in the conventional light assemblies, generally, a hydrophilic antifogging coating is applied to the inner side of the lens so as to prevent the water due to dew condensation from becoming water droplets of small particles, namely, from forming a haze.

As a measure for preventing the haze formation, in a lamp for vehicle (light assembly) according to Patent Document 1, for example, such a configuration is applied in which a baffle plate for accelerating formation of a favorable convection flow in its housing (casing) is provided so as to discharge the moisture out of the housing through an inspiratory port, so that the moisture going around to its front lens is decreased and thus the dew condensation hardly occurs. This makes it possible to reduce the antifogging coating applied to the front lens.

However, although the moisture in the housing can be brought to such a respiratory port by means of convection flow, since the moisture is not sufficiently discharged through the respiratory port in some cases, there is a possibility that the moisture remains in the inner side of the housing.

Instead, it is conceivable to actively remove the moisture in the light assembly using a moisture removal device. Examples of conventional moisture removal devices are given in Patent Documents 2 to 4.

A moisture removal device for vehicle according to Patent Document 2 is configured to dehumidify an atmosphere around an evaporator for vehicle's air conditioner using a proton-conductive type electrolyte film. The moisture removal device is arranged as its anode side being open to a casing of the evaporator and its cathode side being open to an engine room so that the temperature of the cathode side is increased by use of exhaust heat from the engine room, to thereby enhance its dehumidifying effect. It should be noted that this moisture removal device is provided for finally discharging moisture in a vehicle cabin to the engine room, and not for discharging moisture in a headlamp to the outside.

Meanwhile, a moisture prevention structure according to Patent Document 3 is configured by placing in a casing, an electronic component and an electrolyte generating means that converts the intruded moisture to an electrolyte and by filling around them with a resin by injection so that the moisture contained in the resin is decomposed and discharged by flowing a current through the electrolyte generating means. This enhances a moisture-prevention property of the electronic component placed in the engine room of the vehicle. It should be noted that this moisture prevention structure is provided for discharging the moisture intruded in the resin-sealed casing, and not for discharging moisture in a headlamp to the outside.

Meanwhile, an article storage/safekeeping apparatus according to Patent Document 4 is configured by providing a proton conductive member on a wall portion of a housing for storage or safekeeping of an article so that the moisture in the housing is discharged out of the housing. Although this apparatus is provided for discharging the moisture in the housing to the outside of the housing, this housing subject to moisture prevention is not a headlamp.

### CITATION LIST

### Patent Document

Patent Document 1: Japanese Patent Application Laid-open No. 2004-199198
Patent Document 2: Japanese Patent Application Laid-open No. 2007-62562
Patent Document 3: Japanese Patent Application Laid-open No. H11-59289
Patent Document 4: Japanese Patent Application Laid-open No. H05-103941

### SUMMARY OF THE INVENTION

### Problems to be Solved by the Invention

Patent Document 1 is given for accelerating discharge of the moisture in the housing of a headlamp by use of convection flow, and thus not to actively discharge the moisture from the headlamp. Thus, there is a problem that the moisture discharge effect becomes insufficient.

Meanwhile, Patent Documents 2 to 4 are each directed to a configuration of actively discharging moisture by use of an electrolyte member; however, its subject is not a headlamp, and thus no assumption is made about actively discharging the moisture accumulated in a housing of a complex-shape headlamp.

In addition, since a headlamp is mounted on a portion in vicinity of which the engine of the vehicle exists, there is likelihood that a combustible gas such as gasoline, etc., exists around this portion. While at the same time, the electrolyte member is generally configured by laminating on each surface of an electrolyte film, a platinum catalyst layer and a carbon electrode layer, so that a reaction of decomposing into or coupling of, an oxygen ion and a hydrogen ion occurs at the catalyst layer as a surface layer of the electrolyte member. In some cases, this oxygen reacts with the combustible gas to generate heat; however, no description is made about such heat generation in Patent Documents 2 to 4. Further, there is a conceivable risk that the electrolyte film deteriorates or even results in its firing due to the heat generation; however, no description is made about how to deal therewith in Patent Documents 2 to 4.

Accordingly, there is a problem that the moisture removal devices in Patent Documents 2 to 4 are difficult to be used without modification for a headlamp.

The present invention has been made to solve the problems as described above, and an object of the invention is to provide a moisture removal device that suppresses the electrolyte member from being heated up, while exerting a sufficient dehumidifying effect, and a light assembly for on-vehicle use and a light-source lighting device which employ the moisture removal device.

### Means for Solving the Problems

A moisture removal device of this invention comprises:

a plate-like or film-like electrolyte member; a pair of electrode members that sandwich therebetween and make electrically contact with, the electrolyte member from both sides thereof, so as to apply a predetermined voltage to the electrolyte member; and a housing that accommodates the electrolyte member and the pair of electrode members, and has an opening portion which is made open to an inside of a light assembly when the housing is fixed to the light assembly; wherein the pair of electrode members are formed of a material consisting mainly of a metal, and either one of the electrode members is arranged at a position where it closes the opening portion of the housing.

A lighting assembly for on-vehicle use of the invention comprises the aforementioned moisture removal device, to thereby remove moisture in a housing (casing) that accommodates a light source.

A light-source lighting device of the invention comprises: a plate-like or film-like electrolyte member; a pair of electrode members that sandwich therebetween and make electrically contact with, the electrolyte member from both sides thereof, so as to apply a predetermined voltage to the electrolyte member; and a housing (of the lighting device) that accommodates the electrolyte member and the pair of electrode members, and has an opening portion which is made open to an inside of a light assembly when the housing is fixed to the light assembly; wherein the pair of electrode members are formed of a material consisting mainly of a metal, and either one of the electrode members is arranged at a position where it closes the opening portion of the housing (of the lighting device).

### Effect of the Invention

According to the invention, because the pair of electrodes are formed of a material consisting mainly of a metal, the electrolyte member can be suppressed from being heated up. Thus, the moisture removal device is usable even in an atmosphere in which a combustible gas exists.

According to the invention, because of employing the moisture removal device that is usable in an atmosphere in which a combustible gas exists, it is possible to remove the moisture to thereby suppress the dew condensation in a light assembly for on-vehicle use that is arranged near an engine.

According to the invention, because of employing the dehumidifying-function-containing light-source lighting device that is usable in an atmosphere in which a combustible gas exists, it is possible to remove the moisture to thereby suppress the dew condensation in a light assembly for on-vehicle use that is arranged near an engine.

### BRIEF DESCRIPTION OF THE DRAWINGS

FIG. 1 is a cross-sectional view showing a configuration of a headlamp according to Embodiment 1 of the present invention, in a case where a moisture removal device is mounted on its rear surface.

FIG. 2 is a cross-sectional view showing a configuration of a headlamp according to Embodiment 1 of the invention, in a case where a moisture removal device is mounted on its lower surface.

FIG. 3 is diagrams each showing an external appearance of the moisture removal device according to Embodiment 1, in which shown at FIG. 3(a) is a front view, at FIG. 3(b) is a bottom view, and at FIG. 3(c) is a side view.

FIG. 4 is an example of cross-sectional view of the moisture removal device taken along A-A line in FIG. 3.

FIG. 5 is another example of cross-sectional view of the moisture removal device taken along A-A line in FIG. 3.

FIG. 6 is a cross-sectional view showing a configuration of a headlamp according to Embodiment 1 of the invention, in a case where a moisture removal device is mounted on its maintenance cover.

FIG. 7 is a diagram illustrating a fixing method of a headlamp and a moisture removal device according to Embodiment 2 of the invention.

FIG. 8 is a diagram illustrating a fixing method of a headlamp and a moisture removal device according to Embodiment 3 of the invention.

FIG. 9 is a partial cross-sectional view showing a configuration example in which projection portions are formed on an inner circumferential surface of a cylindrical convex portion of a moisture removal device.

FIG. 10 is a diagram illustrating a fixing method of a headlamp and a moisture removal device according to Embodiment 4 of the invention.

FIG. 11 is a partial cross-sectional view showing a state where the headlamp and the moisture removal device are fixed together by the fixing method shown in FIG. 10.

FIG. 12 is a partial cross-sectional view showing a configuration example corresponding to that shown in FIG. 11 provided that concave portions are substituted with cutout holes.

FIG. 13 is a partial cross-sectional view showing a configuration example in which claw portions are formed on an inner circumferential surface of a cylindrical convex portion of a moisture removal device.

FIG. 14 is a diagram illustrating a fixing method of a headlamp and a moisture removal device according to Embodiment 5 of the invention.

FIG. 15 is a partial cross-sectional view showing a state where the headlamp and the moisture removal device are fixed together by the fixing method shown in FIG. 14.

FIG. 16 is a partial cross-sectional view showing a configuration example that uses an elastic member having an O-ring like shape.

FIG. 17 is a partial cross-sectional view showing another configuration example that uses an elastic member having an O-ring like shape.

FIG. 18 is a cross-sectional view showing a configuration of a moisture removal device according to Embodiment 6 of the invention.

FIG. 19 is a circuit diagram showing a basic power source circuit that constitutes a power source unit shown in FIG. 18.

FIG. 20 is a circuit diagram showing another example of power source circuit that constitutes the power source unit shown in FIG. 18.

FIG. 21 is a circuit diagram showing a power source circuit that constitutes a power source unit of a moisture removal device according to Embodiment 7 of the invention.

FIG. 22 is a cross-sectional view showing a configuration of a headlamp according to Embodiment 8 of the invention, in a case where power is supplied from an LED lighting device to a moisture removal device.

FIG. 23 is a cross-sectional view showing a configuration of a headlamp according to Embodiment 8, in a case where an LED lighting device and a moisture removal device are integrated with each other.

### MODES FOR CARRYING OUT THE INVENTION

Hereinafter, for illustrating the invention in more detail, embodiments for carrying out the invention will be described according to the accompanying drawings.

### Embodiment 1

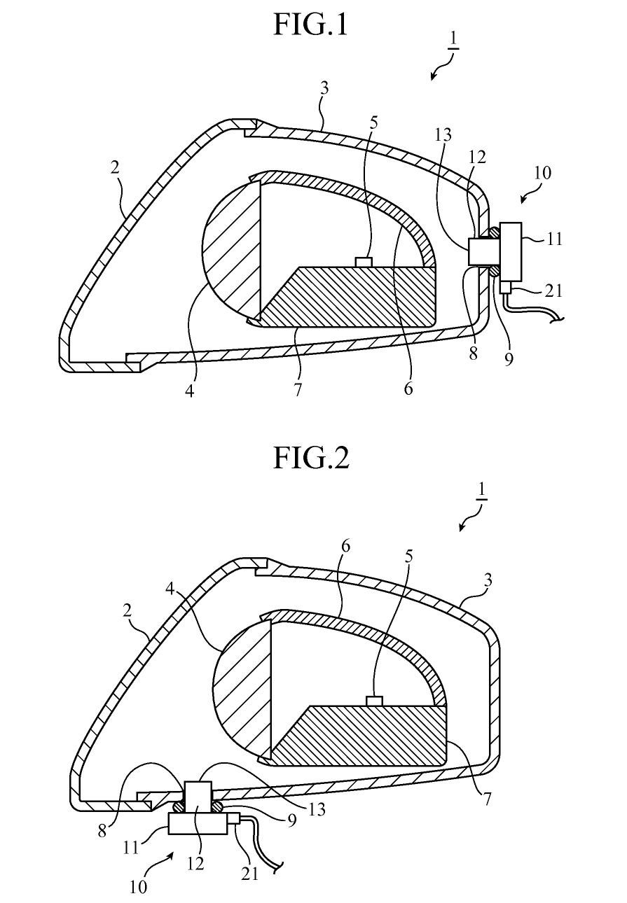

As shown in FIG. 1 and FIG. 2, a headlamp 1 that is one of light assemblies for on-vehicle use (on-vehicle lighting fixtures), is configured with a housing that is formed of a front lens 2 and a casing 3, and that accommodates a projection lens 4 placed on an optical axis extending in a vehicle front-rear direction, an LED (light source) 5 disposed backward from the projection lens 4, a mirror reflector 6 that reflects light from the LED 5 toward the projection lens 4, and a heat sink 7 on which the LED 5 is placed. In the configuration example in FIG. 1, a mounting hole 8 is formed on a rear surface of the casing 3 and a moisture removal device 10 is mounted to the mounting hole 8. In the configuration example in FIG. 2, the mounting hole 8 is formed on a lower surface of the casing 3 and the moisture removal device 10 is mounted thereto.

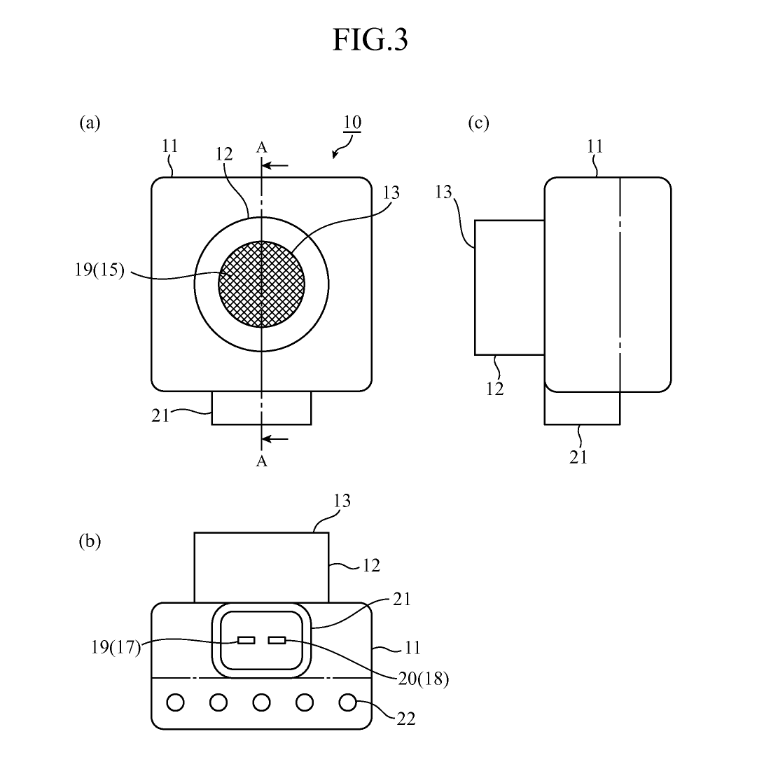

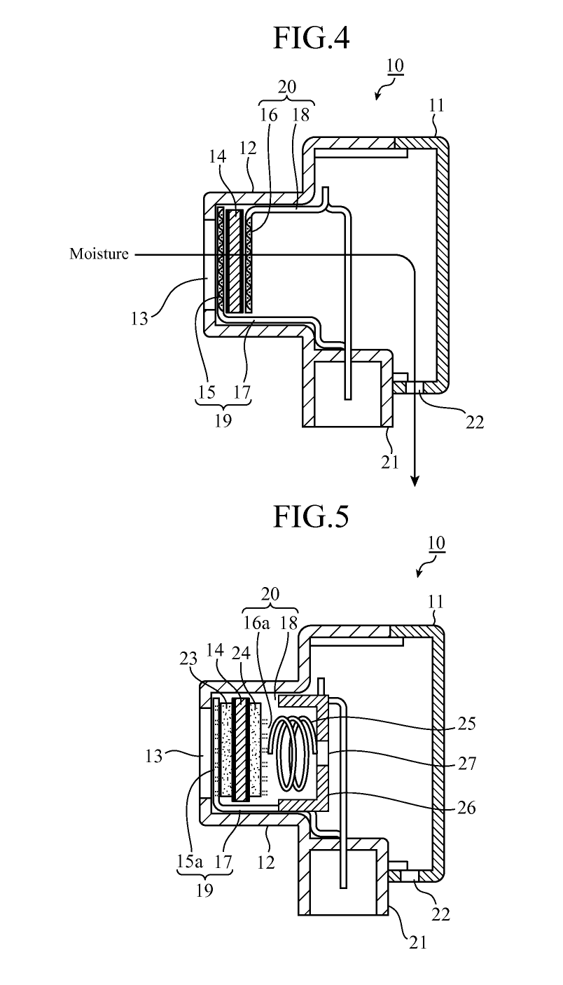

External appearances of the moisture removal device 10 are shown in FIG. 3, and a cross-sectional view taken along A-A line therein is shown in FIG. 4. In the moisture removal device 10, a cylindrical convex portion 12 is protrusively formed in a housing 11. On an end face of the cylindrical convex portion 12, an opening portion 13 is formed. In the cylindrical convex portion 12, a plate-like or film-like electrolyte member 14 is accommodated; to a surface of the electrolyte member 14 at the side toward the opening portion 13, a positive-side electrode member 19 is electrically connected; and to a surface at the other side, a negative-side electrode member 20 is electrically connected. The electrode members 19, 20 are configured with electrode portions 15, 16 that sandwich therebetween and make electrically contact with, the electrolyte member 14, and lead portions 17, 18 that are connected to an external power source (unshown), respectively. Note that the electrode portion 15 of the positive-side electrode member 19 is arranged at a position where it closes the opening portion 13. Further, on the housing 11, a connector portion 21 and a vent port 22 are formed.

The positive-side electrode member 19 and the negative-side electrode member 20 are each formed of a material consisting mainly of a metal. The electrode portions 15, 16 are each formed into almost the same shape as that of the electrolyte member 14 and a mesh-like form, and are in contact with almost all front surface and almost all back surface of the electrolyte member 14, respectively. End portions of the lead portions 17, 18 are routed to the connector portion 21. In Embodiment 1, a voltage (for example, 12V) of an on-vehicle battery is converted into a predetermined voltage (for example, 3V) by a power source device, which is then supplied to the connector portion 21 through power source lines. At the connector portion 21, the power source lines are connected to the end portions of the lead portions 17, 18, so that the predetermined voltage is applied to the electrolyte member 14.

In Embodiment 1, a fluororesin proton-conductive electrolyte is used as the electrolyte member 14, and the electrolyte member 14 is configured to adsorb in-air moisture (humidity). Since the proton-conductive electrolyte is the same as the material for fuel cells, it is large in market volume (production volume) and is thus inexpensive. In other words, the moisture removal device 10 can be achieved with low cost.

Note that catalyst layers consisting mainly of platinum or the like, are formed on the surface layers of the electrolyte member 14, and the electrolyte member 14, in a state covered with the electrode portions 15, 16, closes the opening portion 13. When a positive voltage is applied to the electrode portion 15 and a negative voltage is applied to the electrode portion 16, the moisture adsorbed in the electrolyte member 14 is decomposed into an oxygen ion and a hydrogen ion. Then, gaseous oxygen is discharged from the side of the positive-side electrode portion 15 while gaseous hydrogen is discharged from the side of the negative-side electrode portion 16. Note that, the hydrogen generated at that time reacts with surrounding oxygen to create water (water vapor) in some cases. Thus, seemingly, moisture is absorbed through the positive-voltage applied surface of the electrolyte member 14 and is then discharged through the negative-voltage applied surface thereof.

When the cylindrical convex portion 12 of the moisture removal device 10 is mounted to the mounting hole 8 of the headlamp 1, the electrolyte member 14 absorbs from the side of the electrode portion 15, moisture in the headlamp 1 through the opening portion 13, followed by decomposing it into oxygen and hydrogen, to thereby discharge hydrogen or water from the side of the electrode portion 16 into the housing 11. The hydrogen or water discharged into the housing 11 is discharged to the outside through the vent port 22. Thus, it is possible to decrease the amount of water, namely, humidity, in the headlamp 1. When the amount of water in the headlamp 1 is decreased, as a matter of course, moisture that condenses on the front lens 2 is reduced, so that occurrence of dew condensation in the headlamp 1 is suppressed.

Thus, even if the headlamp 1 has a complex shape, it is possible to actively discharge moisture therein, to thereby suppress occurrence of dew condensation on the front lens 2. As a result, it is possible to reduce the antifogging coating applied to the front lens 2. Further, it is unnecessary to provide, as in a conventional manner, a complex structure for inducing dew condensation to occur at portions other than on the front lens 2.

By the way, since the catalyst layers are formed on the surface layers of the electrolyte member 14, a reaction of decomposing into or coupling of an oxygen ion and a hydrogen ion occurs though being minute. This functions, if there is a combustible gas such as gasoline, etc., in the air, to promote a reaction of the combustible gas with oxygen in the air.

On this occasion, the reaction of the combustible gas with oxygen in the air is accompanied by heat generation, which is minute, so that if the temperature of the electrolyte member 14 is not lowered by dissipating the reaction heat, the electrolyte member 14 itself is deteriorated due to temperature rise.

Further, in a situation where unfavorable conditions coexist, there is concern that the reaction heat is not dissipated but stayed around the electrolyte member 14 resulting in its firing when the temperature rises excessively.

Thus, in the moisture removal device 10 of Embodiment 1, in order to promote dissipation of the reaction heat, the front and back surfaces of the electrolyte member 14 are wholly covered with the mesh-like electrode portions 15, 16 that ensure air-permeability while using a highly heat-conductive metal. Thus, even when there is the combustible gas near the electrolyte member 14 and the combustible gas reacts with oxygen in the air at the surface of the electrolyte member 14, the reaction heat is transferred and diffused by the metallic electrode portions 15, 16 to be dissipated, and thus never locally stays. As a result, the temperature of the electrolyte member 14 does not rise excessively, so that the electrolyte member 14 never deteriorates due to heat generation. Further, since such temperature rise does not occur, the electrolyte member 14 never catches fire.

Furthermore, by closing the opening portion 13 with the robust electrode portion 15 made of a metal to thereby eliminate exposure of the electrolyte member 14, it is possible to prevent a foreign substance, etc., from making contact with the electrolyte member 14. Thus, it can be avoided that the electrolyte member 14 is broken due to an accidental action.

Next, a modified example of the moisture removal device 10 will be described with reference to FIG. 5.

In the moisture removal device 10 shown in FIG. 5, metal plates each having almost the same shape as that of the electrolyte member 14 and a plurality of small holes formed therein, are used as electrode portions 15a, 16a. Namely, even though the metal plates with high heat-conductivity are used, air-permeability is ensured by the small holes formed in the electrode portions. Note that buffer members 23, 24 in a form like a steel wool that is a fibrous metal packed as a felt, for example, are placed between the electrolyte member 14 and the electrode portions 15a, 16a, in order to make uniform pushing forces applied to the front and back surfaces of the electrolyte member 14 without interrupting moisture from entering or leaving the electrolyte member 14 and flow of the current from the electrode portions 15a, 16a.

Further, a bottomed cylindrical support member 26 is attached inside the housing 11, and an elastic member 25 such as a spring is arranged in the support member 26. The elastic member 25 pushes the electrode portion 16a toward the electrolyte member 14, so that the electrode portion 16a, the buffer member 24, the electrolyte member 14, the buffer member 23 and the electrode portion 15a are placed in a contact state to each other, and thus a preferable electrical connection and heat-dissipation effect can be achieved. Note that since the electrode portion 15a is latched onto the fringe portion of the opening portion 13, it does not drop out of the opening portion 13 into the headlamp 1. Further, since a vent hole 27 is formed on the support member 26, the moisture (humidity) passing through the electrolyte member 14 is discharged to the outside by passing through the vent hole 27 and the vent port 22.

Consequently, it is possible to achieve a preferable heat-dissipation effect for the electrolyte member 14 while ensuring its dehumidifying effect, without interrupting preferable electrical connection and passage of moisture inside/outside the electrolyte member 14. Further, since the opening portion 13 is closed with the robust electrode portion 15a made of a metal, it can be avoided that the electrolyte member 14 is broken due to an accidental action.

Note that in the moisture removal device 10 shown in FIG. 5, the buffer members 23, 24 may be omitted so long as the shapes of the electrode portions 15a, 16a are shapes not interrupting passage of moisture toward the electrolyte member 14, flow of the current, and dissipation of the heat.

As described above, by forming the electrode portions 15, 16 or the electrode portions 15a, 16a using a material consisting mainly of a highly heat-conductive metal to thereby develop a configuration having a sufficient heat-dissipation ability, it is possible to make the amount of heat dissipation larger than the amount of heat generation by the reaction of oxygen in the air with the combustible gas. Thus, even when the moisture removal device 10 is used in an environment where the combustible gas exists, the electrolyte member 14 is avoided from being heated up locally, and thus can be prevented from catching fire. Further, the electrolyte member 14 is suppressed from deterioration due to heat generation, so that the dehumidifying capability can be maintained for a long period of time.

Next, a procedure of mounting the moisture removal device 10 to the headlamp 1 will be described.

First, a waterproof member 9 having an O-ring like shape is attached to the outer surface of the cylindrical convex portion 12, and the opening portion 13-side of the cylindrical convex portion 12 is inserted into the mounting hole 8 of the casing 3. Then, the casing 3 and the housing 11 are fixed together by a given fixing means so that the opening portion 13 is placed in a state protruding to the inside of the headlamp 1. Details of the fixing method will be described in Embodiment 2 and later.

Because the opening portion 13 is arranged at a position protruding inwardly from the casing 3 of the headlamp 1, the electrolyte member 14 arranged on the inner side of the opening portion 13 becomes easily exposed to the moisture in the headlamp 1, namely, becomes easily in contact with inner air. Meanwhile, since the waterproof member 9 closes a gap between the outer surface of the cylindrical convex portion 12 and the mounting hole 8, it is possible to prevent water from intruding into the headlamp 1.

As shown in FIG. 1, in the case where the moisture removal device 10 is mounted on the rear surface of the headlamp 1, the moisture (humidity) in the air in the headlamp 1 can be discharged to the outside. Since the rear portion of the headlamp 1 is placed in the engine room, in some cases when the vehicle is traveling, on-road water is splashed from the lower side up to the rear portion of the headlamp 1; however, the rear face of the headlamp 1 is hardly spattered with the water, and thus, it is just enough to provide a simple drip-proof structure on the moisture removal device 10.

On the other hand, in the case where the moisture removal device 10 is mounted on the lower surface of the headlamp 1 as shown in FIG. 2, not only the moisture (humidity) in the air in the headlamp 1 but also water in the form of liquid accumulated at the bottom can be discharged to the outside. However, the lower face of the headlamp 1 is likely to be spattered with the water, and thus it is desired to provide on the moisture removal device 10, a waterproof structure that takes into account the water spatter from the lower side.

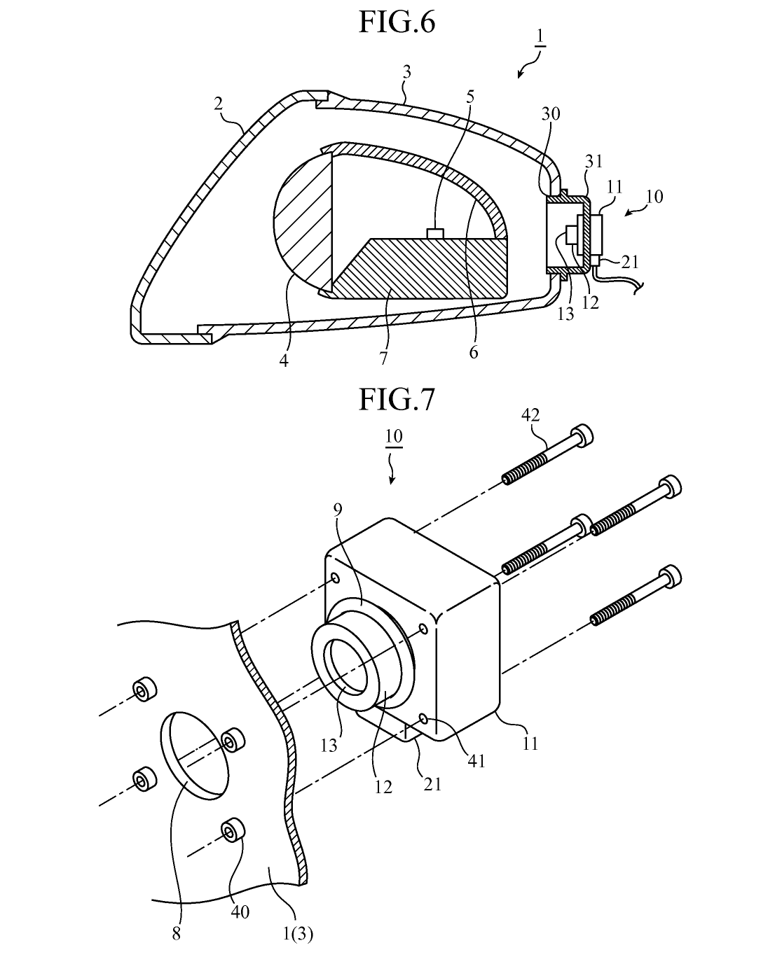

Note that the portion of the moisture removal device 10 to be mounted is not limited to the portions shown in FIG. 1 and FIG. 2. Another example will be described below, with reference to FIG. 6.

Headlamps 1 that employ as a light source a light bulb in which a tungsten filament is red heated, are each provided with a maintenance opening portion 30 that allows replacement of the light bulb when it failed, on the rear surface of the headlamp 1, and a maintenance cover 31 that closes the opening portion.

Meanwhile, the LED 5 has a long life and thus is rarely subject to replacement; however, even in headlamps 1 with a structure that employs the LED 5 as a light source, in many cases, there are included the maintenance opening portion 30 and the maintenance cover 31 that closes the opening portion. This is intended to use the maintenance opening portion 30 in a work for introducing wiring members into the headlamp 1, in assembling works of attaching components in the headlamp 1 or making connection of an internal wiring, for example.

Thus, as shown in FIG. 6, a corresponding portion to the mounting hole 8 in FIG. 1 and FIG. 2 is formed on the maintenance cover 31, and the moisture removal device 10 is mounted to that portion. In the assembling works, the maintenance cover 31 mounted with the moisture removal device 10 is fixed to the maintenance opening portion 30. This makes it unnecessary to form the mounting hole 8 for mounting the moisture removal device 10 on the casing 3 of the headlamp 1. Further, since the moisture removal device 10 is unified to the maintenance cover 31 that is originally included in the headlamp 1, one type of the moisture removal device 1 may be commonly used for headlamps 1 that are different in shape or the like.

Note that it is allowable to employ such a configuration in which the housing 11 of the moisture removal device 10 is integrally formed with the maintenance cover 31.

Next, operational timings of the moisture removal device 10 will be described.

For example, power is constantly supplied from the external power source to the moisture removal device 10, to thereby always activate the dehumidifying function. In this case, since long time dehumidification can be established, it is allowable to make the electrolyte member 14 compact. Thus, the moisture removal device 10 can be achieved with low cost.

Meanwhile, for example, power may be supplied to the moisture removal device 10 in conjunction with the operation of the engine. Namely, during an IG (ignition) switch being turned ON, the power is supplied, and during turned OFF, the power supply is suspended. During the engine operating, its surrounding temperature rises, so that the catalytic activity of the electrolyte member 14 is enhanced to thereby improve the dehumidification efficiency. Further, because of being in conjunction with the IG switch, the operation and its suspension of the moisture removal device 10 can be controlled arbitrarily, and thus it becomes easy to deal with an accidental behavior when occurs.

Meanwhile, for example, power may be supplied to the moisture removal device 10 in conjunction with the operation of the headlamp 1 mounted with the moisture removal device 10 or another light assembly for on-vehicle use (for example, a position lamp). Namely, during lighting, the power is supplied, and during lighting-off, the power supply is suspended. During the headlamp 1 being lighted, the temperature in the headlamp 1 rises, so that a convection flow is produced to thereby agitate the inside air. Thus, by causing the moisture removal device 10 to operate in this duration, it is possible to perform a highly-efficient dehumidifying operation. Accordingly, it is unnecessary to use such an electrolyte member 14 that is excessively large in size. Furthermore, the power source of the moisture removal device 10 can be used in common with the power source of the lighting device for the headlamp 1 or the other light assembly for on-vehicle use, so that the system configuration of the headlamp 1 including the moisture removal device 10 becomes simplified.

As described above, according to Embodiment 1, the moisture removal device 10 is configured to include: the plate-like or film-like electrolyte member 14; the pair of electrode members 19,20 that sandwich therebetween, and make electrically contact with, the electrolyte member 14 from both sides thereof, so as to apply a predetermined voltage to the electrolyte member; and the housing 11 that accommodates the electrolyte member 14 and the pair of electrode members 19, 20, and has the opening portion 13 which is made open to the inside of the headlamp 1 when the housing is fixed to the headlamp 1; wherein the pair of electrode members 19, 20 are formed of a material consisting mainly of a metal, and the positive-side electrode member 19 is arranged at a position where it closes the opening portion 13. Thus, because heat is transferred to be dissipated by the electrode members 19, 20 made of a metal, the electrolyte member 14 can be suppressed from being heated up, so that it becomes possible to use the moisture removal device 10 even in the engine room where a combustible gas exists. Accordingly, occurrence of dew condensation on the front lens 2 can be suppressed by mounting the moisture removal device 10 to the headlamp 1.

Further, according to Embodiment 1, since a proton-conductive electrolyte that is large in market volume and thus is inexpensive is used as the electrolyte member 14, the moisture removal device 10 can be achieved with low cost.

Further, according to Embodiment 1, since it is configured so that the voltage is constantly applied to the electrolyte member 14, it is allowable to make the electrolyte member 14 compact, on the assumption that the dehumidification is performed for a long time. Thus, the moisture removal device 10 can be achieved with low cost.

Instead, it may be configured so that the voltage is applied to the electrolyte member 14 in conjunction with the operation of the engine. In the case of this configuration, since the dehumidification operation can be performed in an environment with a higher surrounding temperature, it is possible to enhance the dehumidification efficiency.

Instead, it may be configured so that the voltage is applied to the electrolyte member 14 in conjunction with the operation of the headlamp 1 or another light assembly mounted on the vehicle on which the headlamp 1 is mounted. In the case of this configuration, since the temperature in the headlamp 1 rises, so that a convection flow is produced to thereby agitate the inside air, it is possible to perform a highly-efficient dehumidifying operation. Further, since the power source can be used commonly for the lighting device of the light source, it is possible to achieve the moisture removal device 10 with a simplified system configuration.

Further, according to Embodiment 1, the moisture removal device 10 is configured to be fixed on the surface opposite to an emitting face of the light from the LED 5, or on the lower-side surface, of the housing formed of the front lens 2 and the casing 3. Thus, it is possible to mount the moisture removal device 10 on a portion according to each purpose.

Further, according to Embodiment 1, the headlamp 1 is provided with the maintenance cover 31 and the moisture removal device 10 is configured to be fixed to the maintenance cover 31. Thus, such a configuration member of the headlamp 1 can be used in a common manner. In addition, it is possible to achieve the moisture removal device 10 that can be attached/detached with reduced effort.

### Embodiment 2

FIG. 7 is a diagram illustrating a fixing method of a headlamp 1 and a moisture removal device 10 according to Embodiment 2, and shows an example of their configurations to be fixed by screw. Note that, in FIG. 7, the same reference numerals are given for the same or equivalent parts as in FIG. 1 to FIG. 6, so that their description is omitted here.

In the case illustrated in the figure, a configuration example is shown in which screw holes (fixing portions) 40 are formed at four locations around the mounting hole 8 formed on the casing 3 of the headlamp 1. In the moisture removal device 10 to be mounted to the headlamp 1 with the above configuration, screw passing holes (fixing members) 41 are formed at four locations on the housing 11. By means of four screws (fixing members) 42, the housing 11 of the moisture removal device 10 is fixed to the casing 3 of the headlamp 1. Further, in order to prevent water from intruding into the headlamp 1 through a gap between the mounting hole 8 and the cylindrical convex portion 12, the waterproof member 9 having an O-ring like shape is arranged between the moisture removal device 10 and the headlamp 1.

Note that, in FIG. 7, the electrolyte member 14, although hidden inside the cylindrical convex portion 12 and thus not seen, is desired to be arranged at a position protruding inwardly from the casing 3 of the headlamp 1, so as to be easily exposed to the moisture in the headlamp 1.

Further, the locations and the number of the screw holes 40 and the screw passing holes 41 are not limited to those in FIG. 7, and may be arbitrarily determined.

The fixing members employed by the moisture removal device 10 may be any members corresponding to the fixing portion of the headlamp 1 and thus may have a configuration other than that using the screws 42 as shown in FIG. 7. For example, in the case where the housing 11 of the moisture removal device 10 is to be fixed to the casing 3 of the headlamp 1 in a state being pushed thereto by use of a fixing member such as a spring, etc., there is formed on the housing 11, a groove, a projection or the like for determining position of the spring so as to prevent its displacement. Note that, also in this case, in order to prevent water from intruding into the headlamp 1, the waterproof member 9 is arranged between the moisture removal device 10 and the headlamp 1.

As described above, according to Embodiment 2, the moisture removal device 10 is configured to include the fixing members, such as the screws 42, etc., corresponding to the fixing portions of the headlamp 1, so that the fixing members fix the housing 11 to the casing 3 of the headlamp 1. Thus, it is possible to provide the moisture removal device 10 that is mountable to the headlamp 1.

### Embodiment 3

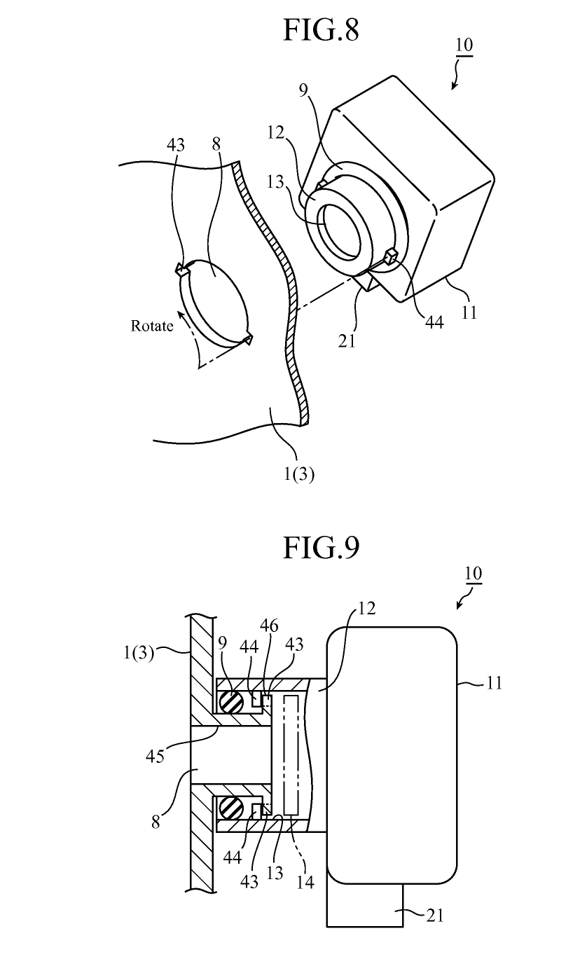

FIG. 8 is a diagram illustrating a fixing method of a headlamp 1 and a moisture removal device 10 according to Embodiment 3, and shows an example of their configurations to be fixed by a bayonet mechanism. Note that, in FIG. 8, the same reference numerals are given for the same or equivalent parts as in FIG. 1 to FIG. 6, so that their description is omitted here.

Cutout portions 43 are formed at two locations of the mounting hole 8 formed on the casing 3 of the headlamp 1, and projection portions 44 to be fitted in the cutout portions 43 are protrusively formed at two locations on the cylindrical convex portion 12 of the moisture removal device 10. Then, the cylindrical convex portion 12 is inserted into the mounting hole 8 while the cutout portions 43 and the projection portions 44 are kept fitted together. After completion of insertion, the moisture removal device 10 is rotated about the center axis of the cylindrical convex portion 12 to thereby latch the projection portions 44 onto the inner-side fringe portion of the mounting hole 8, so that the moisture removal device 10 is fixed to the casing 3 of the headlamp 10. Further, in order to prevent water from intruding into the headlamp 1 through the gap between the mounting hole 8 with the cutout portions 43 and the cylindrical convex portion 12 with the projection portions 44, the waterproof member 9 having an O-ring like shape is arranged between the moisture removal device 10 and the headlamp 1.

Note that, in FIG. 8, the electrolyte member 14, although hidden inside the cylindrical convex portion 12 and thus not seen, is desired to be arranged at a position protruding inwardly from the casing 3 of the headlamp 1, so as to be easily exposed to the moisture in the headlamp 1.

Further, the locations and the number of the cutout portions 43 and the projection portions 44 are not limited to those in FIG. 8, and may be arbitrarily determined.

Further, in FIG. 8, there is given a configuration in which the projection portions 44 are formed on the outer circumferential surface of the cylindrical convex portion 12; however, it may be another configuration in which the projection portions 44 are formed on the inner circumferential surface of the cylindrical convex portion 12. FIG. 9 is a partial cross-sectional view showing a configuration example in which the projection portions 44 are formed on the inner circumferential surface of the cylindrical convex portion 12. In the casing 3 of the headlamp 1, a cylindrical wall 45 is formed that protrudes from the fringe portion of the mounting hole 8 to the outside of headlamp 1, and at the end portion of the cylindrical wall 45, a flange 46 and a plurality of cutout portions 43 are formed. On the inner circumferential surface of the cylindrical convex portion 12 of the moisture removal device 10, a plurality of projection portions 44 to be fitted in the cutout portions 43 are protrusively formed. Then, the cylindrical wall 45 is inserted into the cylindrical convex portion 12 while the cutout portions 43 and the projection portions 44 are kept fitted together. After completion of insertion, the moisture removal device 10 is rotated about the center axis of the cylindrical convex portion 12 to thereby latch the projection portions 44 onto the fringe 46, so that the moisture removal device 10 is fixed to the casing 3 of the headlamp 1.

Note that the electrolyte member 14 and the unshown electrode members 19, 20, etc., are arranged at a location that is a distance back from the flange 46 toward the housing 11. Even in this arrangement, the air in the headlamp 1 makes contact with the electrolyte member 14 through the cylindrical wall 45. Thus, it is possible to remove the moisture.

As described above, according to Embodiment 3, the moisture removal device 10 is configured to include the cylindrical convex portion 12 protrusively formed in the housing 11 and having the opening portion 13 on its end face, and the projection portions 44 formed on a circumferential surface of the cylindrical convex portion 12, so that the housing 11 is fixed to the headlamp 1 in such a manner that the cylindrical convex portion 12 is inserted into the mounting hole 8 formed on the headlamp 1 and the projection portions 44 are latched onto the periphery of the mounting hole 8. Thus, it is possible to provide the moisture removal device 10 that is easily mountable to the headlamp 1.

### Embodiment 4

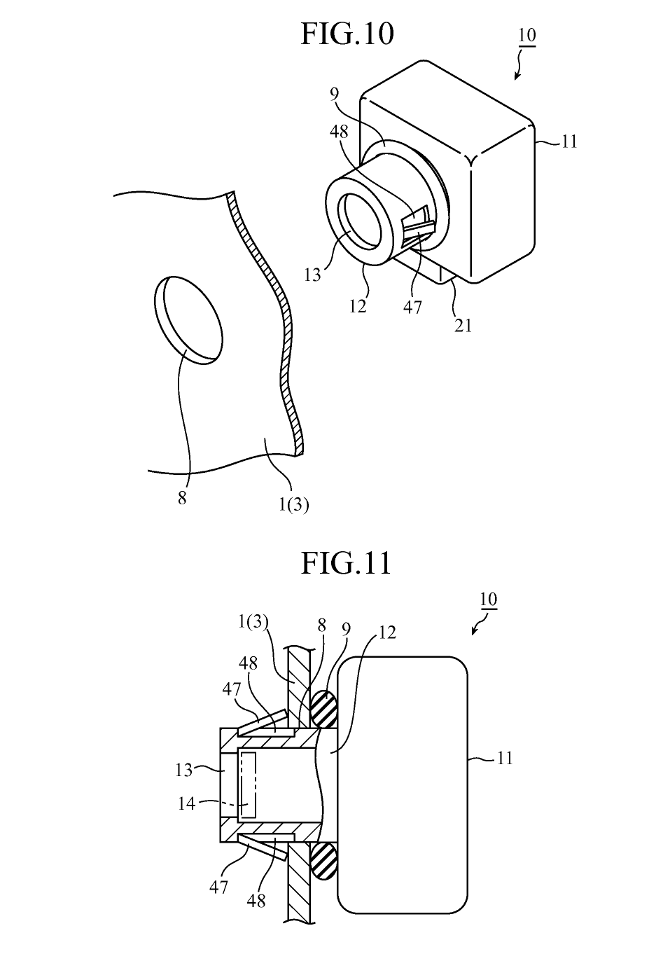

FIG. 10 is a diagram illustrating a fixing method of a headlamp 1 and a moisture removal device 10 according to Embodiment 4 of the invention, and shows an example of their configurations to be fixed by a claw portion. FIG. 11 is a partial cross-sectional view showing a state where the moisture removal device 10 is fixed to the headlamp 1. Note that, in FIG. 10 and FIG. 11, the same reference numerals are given for the same or equivalent parts as in FIG. 1 to FIG. 6, so that their description is omitted here.

At two locations on the outer side of the cylindrical convex portion 12 of the moisture removal device 10, claw portions 47 having elasticity and concave portions 48 that can accommodate the claw portions 47 are provided. Then, the cylindrical convex portion 12 is inserted into the mounting hole 8 while the claw portions 47 are being elastically deformed toward their respective concave portions 48. After completion of insertion, the claw portions 47 return to their outer positions and are latched onto the inner-side fringe portion of the mounting hole 8, to thereby fix the moisture removal device 10 to the casing 3 of the headlamp 1. Further, in order to prevent water from intruding into the headlamp 1 through a gap between the mounting hole 8 and the cylindrical convex portion 12, the waterproof member 9 having an O-ring like shape is arranged between the moisture removal device 10 and the headlamp 1.

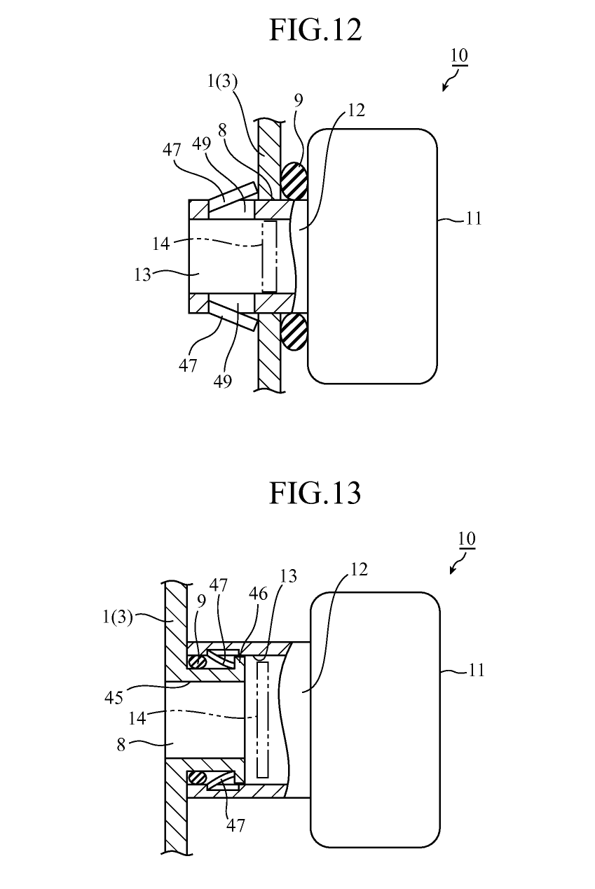

Note that, in FIG. 11, there is given a configuration in which the concave portions 48 that are formed on the outer circumferential surface of the cylindrical convex portion 12, have a depth that does not allow the concave portions to penetrate through the wall of the cylindrical convex portion 12; however, it may be another configuration in which cutout holes 49 that penetrate through the wall of the cylindrical convex portion 12 are formed. FIG. 12 is a partial cross-sectional view showing a configuration example in which the cutout holes 49 are formed on the cylindrical convex portion 12. With this configuration, the air in the headlamp 1 flows in not only through the opening portion 13 but also through the cutout holes 49. Thus, in order to isolate the air in the headlamp 1 and the outside air, the electrolyte member 14 and the unshown electrode members 19, 20, etc., are placed a distance back from the cutout holes 49 toward the housing 11.

Further, in FIG. 10 to FIG. 12, there is given a configuration in which the claw portions 47 are formed on the outer circumferential surface of the cylindrical convex portion 12; however, it may be another configuration in which the claw portions 47 are formed on the inner circumferential surface of the cylindrical convex portion 12. FIG. 13 is a partial cross-sectional view showing a configuration example in which the claw portions 47 are formed on the inner circumferential surface of the cylindrical convex portion 12. On the casing 3 of the headlamp 1, a cylindrical wall 45 is formed that protrudes from the fringe portion of the mounting hole 8 to the outside of headlamp 1, and at the end portion of the cylindrical wall 45, a flange 46 is formed. On the inner circumferential surface of the cylindrical convex portion 12 of the moisture removal device 10, a plurality of the claw portions 47 are formed. Then, the cylindrical convex portion 12 is brought to insertion with the cylindrical wall 45 while the claw portions 47 are being elastically deformed. After completion of insertion, the claw portions 47 return to their inner positions and are latched onto the outer periphery of the cylindrical wall 45 or onto the flange 46, to thereby fix the moisture removal device 10 to the casing 3 of the headlamp 1.

Note that the electrolyte member 14 and the unshown electrode members 19, 20, etc., are arranged at a location that is a distance back from the flange 46 toward the housing 11. Even in this arrangement, the air in the headlamp 1 makes contact with the electrolyte member 14 through the cylindrical wall 45. Thus, it is possible to remove the moisture.

As described above, according to Embodiment 4, the moisture removal device 10 is configured to include the cylindrical convex portion 12 protrusively formed in the housing 11 and having the opening portion 13 on its end face, and the claw portions 47 having elasticity and formed on a circumferential surface of the cylindrical convex portion 12, so that the housing 11 is fixed to the headlamp 1 in such a manner that the cylindrical convex portion 12 is inserted into the mounting hole 8 formed on the headlamp 1 and the claw portions 47 are latched onto the periphery of the mounting hole 8. Thus, it is possible to provide the moisture removal device 10 that is easily mountable to the headlamp 1.

### Embodiment 5

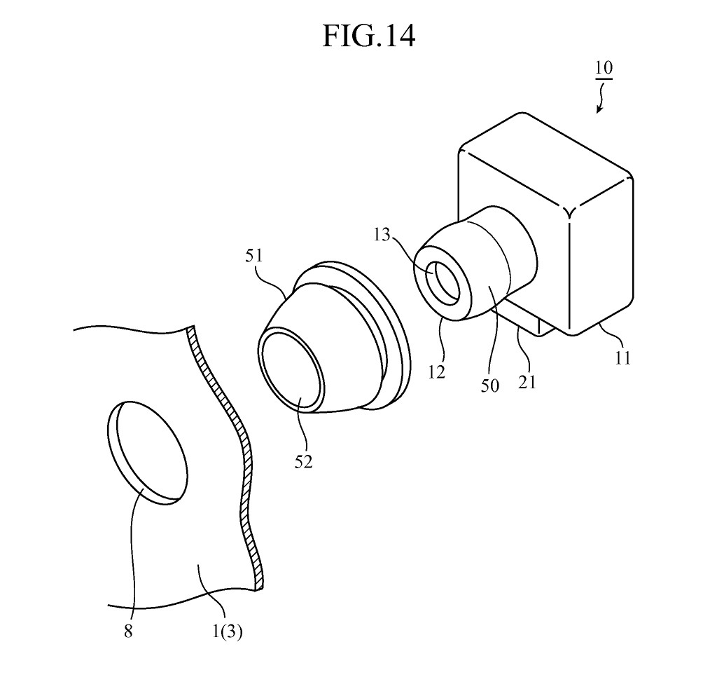

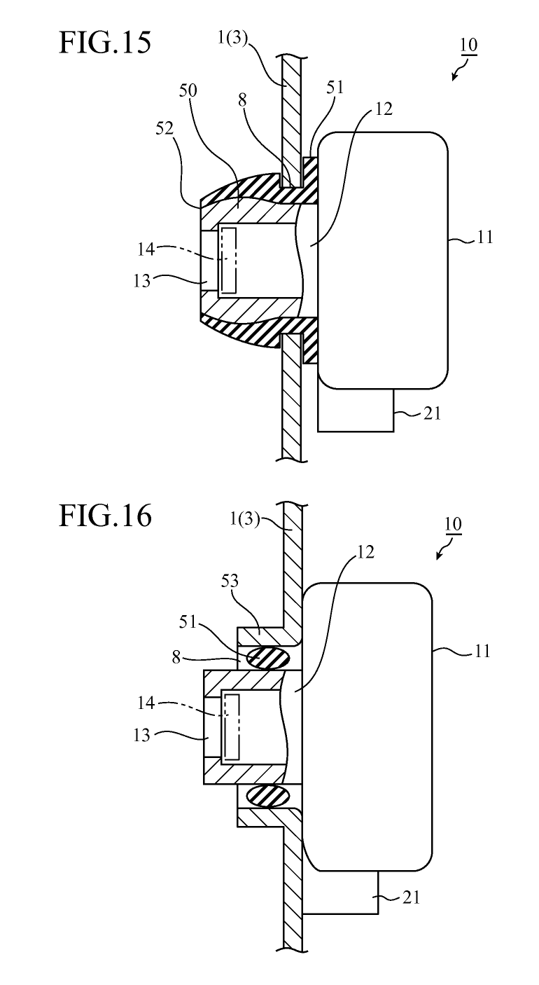

FIG. 14 is a diagram illustrating a fixing method of a headlamp 1 and a moisture removal device 10 according to Embodiment 5 of the invention, and shows an example of their configurations to be fixed by an elastic member. FIG. 5 is a partial cross-sectional view showing a state where the moisture removal device 10 is fixed to the headlamp 1. Note that, in FIG. 14 and FIG. 15, the same reference numerals are given for the same or equivalent parts as in FIG. 1 to FIG. 6, so that their description is omitted here.

At the end portion of the cylindrical convex portion 12 of the moisture removal device 10, a large-diameter portion 50 having a diameter larger than the outer diameter of the base end portion is formed. To the mounting hole 8 formed on the casing 3 of the headlamp 1, a circular elastic member 51 is attached beforehand. Then, the cylindrical convex portion 12 is press-fitted into the fitting hole 52 of the elastic member 51 while the large-diameter portion 50 is pushing out the fitting hole, to thereby fix the moisture removal device 10 to the casing 3 of the headlamp 1 using a repulsive force (elastic force) of the elastic member 51. By forming the large-diameter portion 50 on the cylindrical convex portion 12, it becomes possible to firmly mount the cylindrical convex portion 12 to the elastic member 51, so that with a simple configuration, the moisture removal device 10 is prevented from dropping out. In addition, the elastic member 51 functions concurrently as the waterproof member 9 in the above configuration.

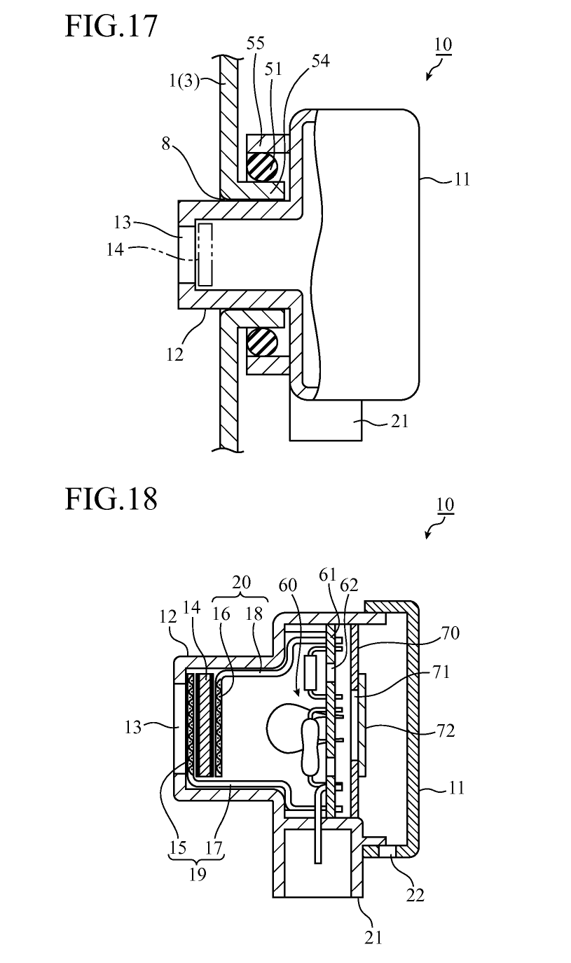

Note that, in FIG. 14 and FIG. 15, there is shown a case of using the elastic member 51 having a grommet (bush) like shape; however, the shape of the elastic member 51 is not limited thereto. FIG. 16 and FIG. 17 are partial cross-sectional views each showing a configuration example that uses an elastic member 51 having an O-ring like shape.

In the configuration example of FIG. 16, a cylindrical wall 53 is formed that protrudes inwardly from the fringe portion of the mounting hole 8 formed on the casing 3 of the headlamp 1. Then, between the inner surface of the cylindrical wall 53 and the outer surface of the cylindrical convex portion 12, the elastic member 51 having an O-ring shape is placed so as to abut these surfaces, to thereby fix the moisture removal device 10 to the casing 3 of the headlamp 1 using a repulsive force of the elastic member 51.

In the configuration example of FIG. 17, a cylindrical wall 54 is formed that protrudes outwardly from the fringe portion of the mounting hole 8 formed on the casing 3 of the headlamp 1. On the housing 11 of the moisture removal device 10, a cylindrical wall 55 is formed so that it surrounds the outer surface of the cylindrical convex portion 12. Then, between the outer surface of the cylindrical wall 54 and the inner surface of the cylindrical wall 55, the elastic member 51 having an O-ring shape is placed so as to abut these surfaces, to thereby fix the moisture removal device 10 to the casing 3 of the headlamp 1 using a repulsive force of the elastic member 51.

As described above, according to Embodiment 5, the moisture removal device 10 is configured to include the cylindrical convex portion 12 protrusively formed in the housing 11 and having the opening portion 13 on its end face, and the cyclic elastic member 51, so that the housing 11 is fixed to the headlamp 1 using the elastic force of the elastic member 51 in such a manner that the cylindrical convex portion 12 is inserted into the mounting hole 8 formed on the headlamp 1 and the elastic member 51 is arranged between the mounting hole 8 and the cylindrical convex portion 12. Thus, it is possible to provide the moisture removal device 10 that is easily mountable to the headlamp 1.

### Embodiment 6

FIG. 18 is a cross-sectional view showing a configuration of a moisture removal device 10 according to Embodiment 6. Note that, in FIG. 18, the same reference numerals are given for the same or equivalent parts as in FIG. 1 to FIG. 6, so that their description is omitted here.

The moisture removal device 10 according to Embodiment 1 is configured to receive a power supply, for example, of 3V, through the connector portion 21, and thus a power source device that converts 12V of the on-vehicle battery to 3V is separately required. In contrast, according to Embodiment 6, a power source unit 60 for converting 12V to 3V is built in the moisture removal device 10 so that the device can be connected to the on-vehicle battery by way of the power source unit 60. Electronic components that constitute the power source unit 60 are mounted on a circuit board 61 to which the end portions of the lead portions 17, 18 are connected. Further, a vent hole 62 is formed on the circuit board 61.

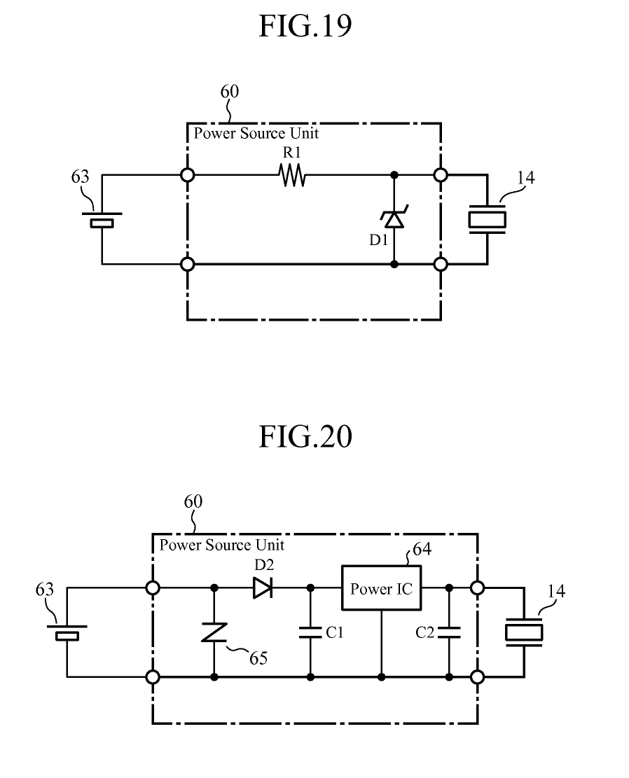

In FIG. 19, a basic power source circuit that constitutes the power source unit 60 is shown. In this example, a constant voltage circuit is constituted by a resistor R1 and a zener diode D1. This makes unnecessary the power source device that is separately provided in Embodiment 1.

Note that, at the time of high humidity, the resistance component of the electrolyte member 14 is decreased to thereby increase the flow of the current, so that, in some cases, it becomes unable to flow a sufficient output current by the above circuit configuration using the resistor R1 and the zener diode D1. Thus, the power source unit 60 may be configured with a power IC for constant voltage circuit, in order to flow a large output current to thereby cause the moisture removal device 10 to sufficiently exhibit its function at the time of high humidity. In an example of circuit configuration shown in FIG. 20, a constant-voltage power source is constituted by a power (source) IC (Integrated Circuit) 64, capacitors C1, C2 for stabilizing the operation of the power IC 64, a protection diode D2 and an overvoltage protection element 65 such as a varistor or the like.

As described also in Embodiment 1, the dehumidifying function may be always activated by constantly supplying power from the on-vehicle battery 63 to the power source unit 60. Instead, the power may be supplied in conjunction with the operation of the engine. Further, the power may be supplied in conjunction with the lighting operation of the light assembly for on-vehicle use, such as the headlamp 1 or the like.

Note that, in the case where the power source unit 60 is built in the moisture removal device 10, it is desirable that the moisture removal device 10 be formed into a waterproof structure in order to prevent water from intruding into the power source unit 60 to cause an abnormal operation. Thus, in the configuration example of FIG. 18, a partition wall 70 is provided in the housing 11 at a border between the power source unit 60 and the outer air, and a vent hole 71 of the partition wall 70 is closed by an air-permeable waterproof member 72. The air-permeable waterproof member 72 does not allow water to permeate therethrough but allow water vapor to permeate therethrough. Thus, the operation of the moisture removal device 10 for discharging the moisture in the headlamp 1 by converting it into hydrogen or water vapor is not inhibited. The moisture (humidity) that is discharged into the moisture removal device 10 after passing through the electrolyte member 14, is discharge from the vent port 22 to the outside through the vent hole 62 formed in the circuit board 61 of the power source unit 60 and the vent hole 71 formed in the partition wall 70. Meanwhile, if water intrudes from the vent port 22 into the housing 11, since the water is prevented by the partition wall 70 from intruding into the side of the power source unit 60, it is possible to avoid an abnormal operation of the power source unit 60 due to water immersion, to thereby enhance the reliability.

The electrode members 19, 20 that sandwich the electrolyte member 14 of the moisture removal device 10, are arranged alongside of a wall surface of the housing 11 that serves to fix the electrode members 19, 20, and thus, there is no airtightness between the electrode members 19, 20 and the housing 11 unless a special configuration is given therefor. In other words, an air passageway for making communication between the inside and the outside of the headlamp 1, is formed through gaps between the electrode members 19, 20 and the housing 11, and through the vent hole 62, the vent hole 71 and the vent port 22. Thus, it is possible to relieve the pressure produced due to expansion and contraction of air in the headlamp 1.

Note that even in the conventional headlamp 1, a ventilation component is mounted which is provided with: an air passageway for expansion and contraction of the inner air; and an air-permeable waterproof member that prevents water from intruding through the air passageway. However, since the moisture removal device 10 shown in FIG. 18 has also a function of the conventional ventilation component, the conventional ventilation component is unnecessary and thus may be omitted.

As described above, according to Embodiment 6, the moisture removal device 10 is configured to include the power source unit 60 that converts the voltage of the on-vehicle battery 63 to a predetermined voltage to be applied to the electrolyte member 14, and then supplies it to the pair of the electrode members 19, 20. Thus, it is possible to achieve the moisture removal device 10 that can receive a power supply directly from the on-vehicle battery 63.

Further, according to Embodiment 6, the moisture removal device 10 is configured to include the vent port 22 for making communication between the inside and the outside of the housing 11, and the air-permeable waterproof member 72 arranged in the housing 11 and nearer to the vent port 22 than to the electrolyte member 14. Thus, it becomes possible to avoid the abnormal operation due to water immersion, to thereby achieve the moisture removal device with high reliability. Further, the conventional-type ventilation component for the headlamp 1 may be omitted, so that it is possible to improve ease of assembly of the headlamp 1 to thereby reduce its cost.

### Embodiment 7

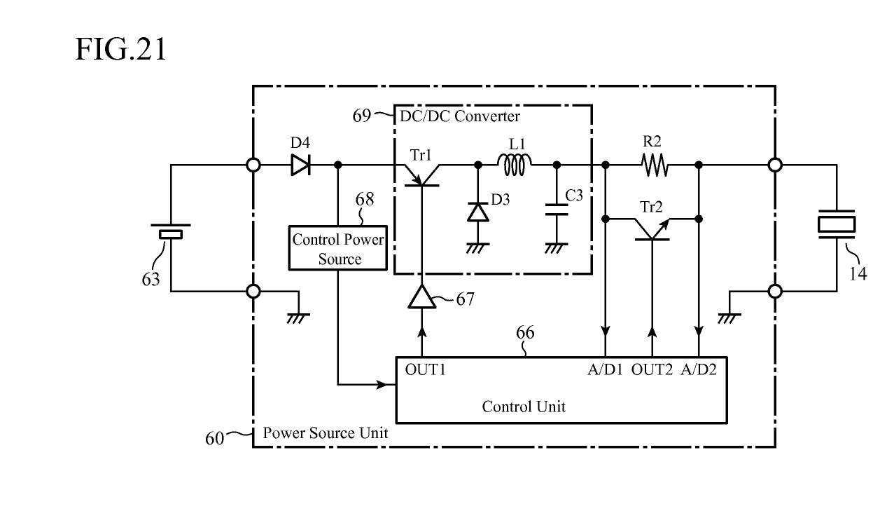

FIG. 21 is a circuit diagram showing a configuration example developed from the above power source unit 60, of a moisture removal device 10 according to Embodiment 7. Note that, in FIG. 21, the same reference numerals are given for the same or equivalent parts as in FIG. 18 to FIG. 20, so that their description is omitted here.

As described previously, the electrolyte member 14 has a property of changing its resistance value depending on an amount of water due to absorption of moisture. Thus, according to Embodiment 7, under utilization of this property, it is configured to use the electrolyte member 14 as a humidity sensor, so that power is supplied from the power source unit 60 to the electrolyte member 14 arbitrarily in conjunction with the humidity in the headlamp 1.

As shown in FIG. 21, the power source unit 60 includes a DC/DC converter 69 configured with a switching element Tr1 such as a transistor, a diode D3, a coil L1 and a capacitor C3, to generate a voltage to be applied to the electrolyte member 14 (for example, 3V) by use of the DC/DC converter 69. Further, a resistor R2 is serially connected between the DC/DC converter 69 and the electrolyte member 14, and a switching element Tr2, such as a transistor, is connected in parallel with the resistor R2.

A control unit 66 is configured with a microcomputer that includes a CPU (Central Processing Unit), output terminals OUT1, 2, analog input terminals A/D1, 2, and so on. The control unit 66 outputs from the output terminal OUT1, an activation signal for the switching element Tr1 through a driver 67, to thereby control the operation of the DC/DC converter. A control power source 68 generates power for activating the control unit 66.

The control unit 66, when causing the electrolyte member 14 to perform dehumidifying operation, turns on the switching element Tr2 to thereby apply a voltage of 3V output by the DC/DC converter to the electrolyte member 14.

In contrast, when using the electrolyte member 14 as a humidity sensor, the switching element Tr2 is turned off by the control unit 66 so as to place the resistor R2 in serial connection, to thereby apply a voltage to the electrolyte member 14. On this occasion, the control unit 66 detects a value of divided voltage between the resistor R2 and the electrolyte member 14 as a terminal voltage value of the input terminal A/D2.

If the resistor R2 is set to a given resistance value, a resistance value between the terminals of the electrolyte member 14 can be calculated from a ratio between the voltage across the terminals of the resistor R2 and the voltage across the terminals of the electrolyte member 14 (a ratio between the terminal voltages at the input terminals A/D1, 2). The resistance value between the terminals of the electrolyte member 14 corresponds to an amount of water due to absorption of moisture, namely, a humidity in the internal space of the headlamp 1, so that the humidity can be estimated based on the resistance value between the terminals.

The control unit 66 periodically estimates the humidity in the headlamp 1, and when the humidity is higher than a predetermined threshold value, turns on the switching element Tr2 to apply the output voltage of the DC/DC converter 69 to the electrolyte member 14, so that the dehumidifying operation is performed. In contrast, when the humidity is the threshold value or lower, the control unit suspends the DC/DC converter 69, so that no dehumidifying operation is performed. This makes it possible to cause the moisture removal device 10 to perform the operation when necessary and to suspend the operation when unnecessary, so that the life of the electrolyte member 14 can be prolonged while reducing the applied power to the moisture removal device 10.

Further, since the DC/DC converter 69 is acceptable to output a large current, its capability is further enhanced than that of the power source unit 60 illustrated in FIG. 20 of Embodiment 6. Thus, not only in the case of dealing with the moisture in the air, but also in the situation where a water droplet or water (liquid) adheres to the electrolyte member 14 so that its resistance is decreased and thus the flow of the current is increased, it is possible to remove moisture, in other words, to discharge water. Note that the power source unit 60 may be configured so that the humidity in the headlamp 1 is detected using a different humidity sensor from the electrolyte member 14.

As describe above, according to Embodiment 7, the moisture removal device 10 is configured to use the electrolyte member 14 as a moisture sensor, to thereby operate in conjunction with the humidity in the headlamp 1 detected using the electrolyte member 14. Thus, it becomes possible to perform dehumidification operation only at the time the humidity in the headlamp 1 is high, so that the life of the electrolyte member 14 can be prolonged while reducing the applied power.

Note that the power source unit 60 to be used in each of Embodiments 1 to 5 and 7 may be configured as an independent power source device so that this power source device converts 12V of the on-vehicle battery 63 to 3V and supplies it to the moisture removal device 10. Further, the power source device may be mounted to the headlamp 1 together with a light-source lighting device and the like. With this configuration, a wiring from the vehicle-body side to the light-source lighting device or the like, can be commonly used, and thus, no special wiring is necessary to be laid from the vehicle-body side to the moisture removal device 10. Thus, it is possible to achieve the headlamp 1 that is easy to be handled.

### Embodiment 8

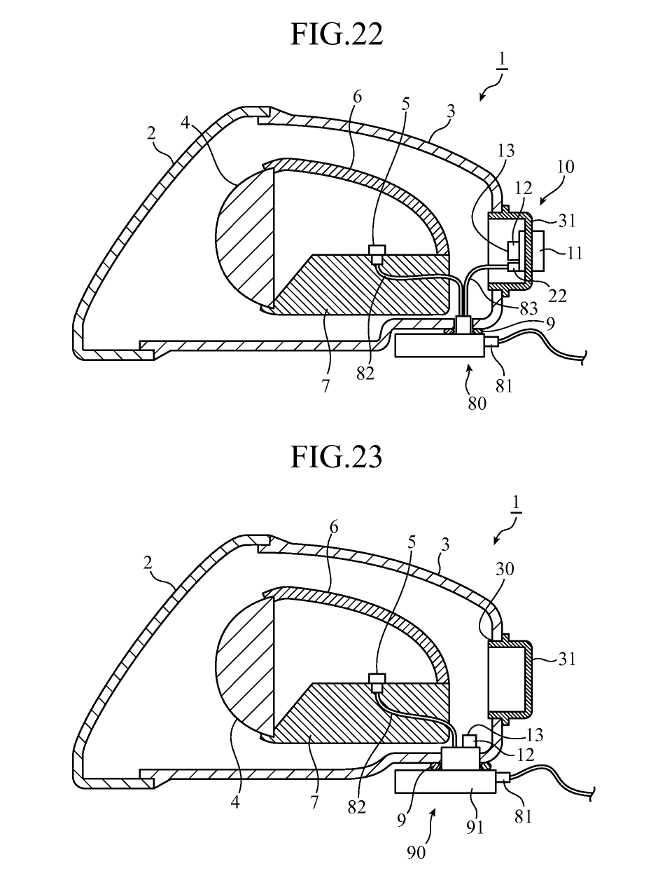

FIG. 22 is a cross-sectional view showing a configuration of a headlamp 1 according to Embodiment 8. Note that, in FIG. 22, the same reference numerals are given for the same or equivalent parts as in FIG. 1 to FIG. 17, so that their description is omitted here.

To a connector portion 81 of an LED lighting device (light-source lighting device) 80 equipped with a power source for moisture removal device, a power line extending from the on-vehicle battery is connected. The LED lighting device 80 equipped with a power source for moisture removal device converts, using its built-in DC/DC converter (unshown), the power of the on-vehicle battery applied through the connector portion 81, to the power for lighting the LED 5, and then supplies it to the LED 5 through a power line for lighting 82.

In Embodiment 8, such a configuration is employed in which the power for causing the moisture removal device 10 to perform dehumidifying operation is supplied by the LED lighting device 80 equipped with a power source for moisture removal device. For example, the power for dehumidification by the moisture removal device 10 is taken out from a secondary winding of a transformer in the DC/DC converter that is built in the LED lighting device 80 equipped with a power source for moisture removal device, and is supplied to the moisture removal device 10 through a power line for dehumidification 83. Instead, another configuration may be employed in which the LED lighting device 80 equipped with a power source for moisture removal device, has a built-in power source unit 60 as shown in FIG. 19 to FIG. 21, so that the power of the on-vehicle battery applied through the connector portion 81 is converted to the power for dehumidification and supplied to the moisture removal device 10 through the power line for dehumidification 83.

Note that, in FIG. 22, although a configuration example is shown in which the moisture removal device 10 is mounted on the maintenance cover 31, it may be mounted on the casing 3 as shown in FIG. 1 or FIG. 2.

Furthermore, the LED lighting device 80 equipped with a power source for moisture removal device, and the moisture removal device 10 may be integrated with each other. In FIG. 23, the headlamp 1 is shown that mounts thereon a dehumidifying-function-containing LED lighting device 90 in which a dehumidifying function is incorporated. In this example, an integrated housing 91 is used that integrates a housing of the LED lighting device 80 equipped with a power source for moisture removal device, and the housing 11 of the moisture removal device 10. On the integrated housing 91, an opening portion 13 is formed similarly to the housing 11 of the moisture removal device 10. Further, in the integrated housing 91, the respective components such as the electrolyte member 14, the electrode members 19, 20, etc., that constitute the moisture removal device 10, are accommodated. In addition, in the integrated housing 91, the respective components such as the DC/DC converter, etc., that constitute the LED lighting device 80 equipped with a power source for moisture removal device, are accommodated. The dehumidifying-function-containing LED lighting device 90 with this configuration converts the power of the on-vehicle battery to the power for lighting the LED 5 thereby supplying it to the LED 5 through the power line for lighting 82, as well as converts to the power for dehumidification by the moisture removal device 10 thereby supplying it to the electrolyte member 14 in the integrated housing 91.

As described above, according to Embodiment 8, the headlamp 1 is configured to include the LED lighting device 80 equipped with a power source for moisture removal device that converts the voltage of the on-vehicle battery 63 to a predetermined voltage for lighting and supplies it to the LED 5, wherein the LED lighting device 80 equipped with a power source for moisture removal device converts the voltage of the on-vehicle battery 63 to a predetermined voltage to be applied to the electrolyte member 14 and supplies it to the moisture removal device 10. Thus, it is unnecessary to individually provide the respective power sources for the LED 5 and the moisture removal device 10, and thus the headlamp 1 can be achieved with a simple configuration.

Further, according to Embodiment 8, the headlamp 1 is configured to include the dehumidifying-function-containing LED lighting device 90 that has a function of converting the voltage of the on-vehicle battery 63 to a predetermined voltage for lighting and supplying it to the LED 5, and a dehumidifying function; wherein, the housing 11 of the moisture removal device 10 is formed as the integrated housing 91 that is integrally configured with the housing of the dehumidifying-function-containing LED lighting device 90; the integrated housing 91 accommodates the components of the LED lighting device 80 equipped with a power source for moisture removal device, the electrolyte member 14 and the pair of electrodes 19,20; the opening portion 13 is formed that is made open to the inside of the headlamp 1 when the integrated housing 91 is fixed to the casing 3 of the headlamp 1; and the dehumidifying-function-containing LED lighting device 90 converts the voltage of the on-vehicle battery 63 to the predetermined voltage to be applied to the electrolyte member 14 and supplies it to the pair of the electrode members 19, 20 in the integrated housing 91. Thus, it is unnecessary to independently provide the moisture removal device 10, and thus the headlamp 1 can be achieved with a simple configuration.

Note that in Embodiments 1 to 8, there are shown the cases of using the LED 5 as a light source; however, a discharge lamp, a tungsten filament light bulb or the like may be used other than the LED.

Further, other than the headlamp 1, the light assembly for on-vehicle use may be a tail lamp, a fog lamp, a turn-signal lamp, a position lamp, or the like. For the light assembly that has a large light emitting area, namely, whose dew condensation is likely to be visually recognized, the moisture removal device 10 is effective.

Other than the above, unlimited combination of the respective embodiments, modification of any configuration element in the embodiments and omission of any configuration element in the embodiments may be made in the present invention without departing from the scope of the invention.

### INDUSTRIAL APPLICABILITY

As described above, the moisture removal device according to the invention is configured to transfer and dissipate the heat generated by the electrolyte member by use of the electrode members made of a metal, so that it is suited to be used for alight assembly for on-vehicle use arranged in an engine room where a combustible gas exists.

### DESCRIPTION OF REFERENCE NUMERALS and SIGNS

1: headlamp, 2: front lens, 3: casing, 4 projection lens, 5, LED, 6: mirror reflector, 7: heat sink, 8: mounting hole, 9: waterproof member, 10: moisture removal device, 11: housing, 12: cylindrical convex portion, 13: opening portion, 14: electrolyte member, 15, 15a, 16, 16a: electrode portions, 17, 18: lead portions, 19: positive-side electrode member, 20: negative-side electrode member, 21: connector portion, 22: vent port, 23, 24: buffer members, 25: elastic member, 26: support member, 27: vent hole, 30: maintenance opening portion, 31: maintenance cover, 40: screw hole, 41: screw passing hole, 42: screw, 43: cutout portion, 44: projection portion, 45: cylindrical wall, 46: flange, 47: claw portion, 48: concave portion, 49: cutout hole, 50: large-diameter portion, 51: elastic portion, 52: fitting hole, 53: cylindrical wall, 54: cylindrical wall, 55: cylindrical wall, 60: power source unit, 61: circuit board, 62: vent hole, 63: on-vehicle battery, 64: power IC, 65: overvoltage protection element, 66: CPU, 67: driver, 68: control power source, 69: DC/DC converter, 70: partition wall, 71: vent hole, 72: air-permeable waterproof member, 80: LED lighting device equipped with a power source for moisture removal device, 81: connector portion, 82: power line for lighting, 83: power line for dehumidification, 90: dehumidifying-function-containing LED lighting device, 91: integrated housing.

1. A moisture removal device to be fixed to a light assembly mounted on a vehicle, for removing moisture in the light assembly, comprising:
a plate-like or film-like electrolyte member;
a pair of electrode members that sandwich therebetween and make electrically contact with, the electrolyte member from both sides thereof, so as to apply a predetermined voltage to the electrolyte member; and
a housing that accommodates the electrolyte member and the pair of electrode members, and has an opening portion which is made open to an inside of the light assembly when the housing is fixed to the light assembly;
wherein the pair of electrode members are formed of a material consisting mainly of a metal, and either one of the electrode members is arranged at a position where it closes the opening portion.

2. The moisture removal device of claim 1, further comprising a fixing member that corresponds to a fixing portion of the light assembly, so as to fix the housing to the light assembly.

3. The moisture removal device of claim 1, further comprising a cylindrical convex portion that is protrusively formed in the housing and has an end face on which the opening portion is formed, and a projection portion formed on a circumferential surface of the cylindrical convex portion,
wherein the housing is fixed to the light assembly in such a manner that the cylindrical convex portion is inserted into a mounting hole formed on the light assembly and the projection portion is latched onto a periphery of the mounting hole.

4. The moisture removal device of claim 1, further comprising a cylindrical convex portion that is protrusively formed in the housing and has an end face on which the opening portion is formed, and a claw portion having elasticity that is formed on a circumferential surface of the cylindrical convex portion;
wherein the housing is fixed to the light assembly in such a manner that the cylindrical convex portion is inserted into a mounting hole formed on the light assembly and the claw portion is latched onto a periphery of the mounting hole.

5. The moisture removal device of claim 1, further comprising a cylindrical convex portion that is protrusively formed in the housing and has an end face on which the opening portion is formed, and a circular elastic member;
wherein the housing is fixed to the light assembly using elastic force of the elastic member in such a manner that the cylindrical convex portion is inserted into a mounting hole formed on the light assembly and the elastic member is arranged in between the mounting hole and the cylindrical convex portion.

6. The moisture removal device of claim 1, wherein the moisture removal device is fixed to, or formed integrally with, a maintenance cover attached to the light assembly.

7. The moisture removal device of claim 1, further comprising a power source unit that converts a voltage of an on-vehicle power source to the predetermined voltage to be applied to the electrolyte member, and supplies it to the pair of electrode members.

8. The moisture removal device of claim 1, further comprising a vent port for making communication between inside and outside of the housing, and an air-permeable waterproof member arranged in the housing nearer to the vent port than to the electrolyte member.

9. The moisture removal device of claim 1, wherein the electrolyte member is formed of a proton-conductive electrolyte.

10. The moisture removal device of claim 1, wherein the electrolyte member is used as a humidity sensor.

11. The moisture removal device of claim 1, wherein the voltage is constantly applied to the electrolyte member.

12. The moisture removal device of claim 1, wherein the voltage is applied to the electrolyte member in conjunction with an operation of an engine.

13. The moisture removal device of claim 1, wherein the voltage is applied to the electrolyte member in conjunction with an operation of the light assembly to which the moisture removal device is fixed or another light assembly mounted on the vehicle.

14. The moisture removal device of claim 1, wherein the voltage is applied to the electrolyte member in conjunction with a humidity in the light assembly.

15. A light assembly for on-vehicle use which comprises the moisture removal device described in claim 1, to thereby remove moisture in a housing that accommodates a light source.

16. The light assembly of claim 15, which is a headlamp or a tail lamp.

17. A light-source lighting device that converts a voltage of an on-vehicle power source to a predetermined voltage for lighting, and supplies it to a light source of a light assembly,
said light-source lighting device comprising, as a part of its functions, a power source that converts the voltage of the on-vehicle power source to another predetermined voltage and supplies it to the moisture removal device described in claim 1.

18. A light assembly for on-vehicle use which comprises the moisture removal device described in claim 1 and the light-source lighting device described in claim 17 having a power supplying function to the moisture removal device, to thereby remove moisture in a housing that accommodates a light source.

19. A light-source lighting device that converts a voltage of an on-vehicle power source to a predetermined voltage for lighting, and supplies it to a light source of a light assembly,
said light-source lighting device comprising, as a part of its functions, the moisture removal device described in claim 1 and a power source that converts the voltage of the on-vehicle power source to another predetermined voltage and supplies it to the moisture removal device.

20. A light assembly which comprises the light-source lighting device described in claim 19, to thereby remove moisture in a housing that accommodates a light source.
